(19) United States
(12) Patent Application Publication
(10) Pub. No.: US 2025/0334549 A1
(43) Pub. Date: Oct. 30, 2025

(54) METHOD OF PREDICTING ACOUSTIC PERFORMANCE OF POROUS POLYMER MATERIAL AND PROGRAM TO PERFORM SAME

(71) Applicants: Hyundai Motor Company, Seoul (KR); Kia Corporation, Seoul (KR); SEOUL NATIONAL UNIVERSITY R&DB FOUNDATION, Seoul (KR)

(72) Inventors: Jung Wook Lee, Seoul (KR); Yeon June Kang, Seoul (KR); Sung Soo Yang, Seoul (KR); Jun Heo, Seoul (KR)

(21) Appl. No.: 18/943,790

(22) Filed: Nov. 11, 2024

(30) Foreign Application Priority Data
Apr. 29, 2024 (KR) 10-2024-0056492

(51) Int. Cl. G01N 29/04; G01N 29/44

(52) U.S. Cl. CPC G01N 29/04; G01N 29/4418; G01N 2291/0235

(57) ABSTRACT

A method of predicting acoustic performance of a porous polymer material includes measuring initial properties of the polymer material including non-acoustic properties and mechanical properties, calculating properties after deterioration by inputting the initial properties into a deterioration model, and calculating acoustic performance after deterioration of the polymer material by inputting the properties after deterioration into an acoustic model, in order to enable acoustic performance of the polymer material deteriorated by time and temperature to be predicted with high accuracy.

### CROSS-REFERENCE TO RELATED APPLICATION

This application claims under 35 U.S.C. § 119(a) the benefit of Korean Patent Application No. 10-2024-0056492, filed on Apr. 29, 2024, the entire contents of which are incorporated herein by reference.

### BACKGROUND

### (a) Technical Field

The present disclosure relates to a method of predicting acoustic performance of a porous polymer material and a program to perform the same, in order to predict the acoustic performance of the polymer material that typically is deteriorated by time and temperature.

### (b) Description of the Related Art

The Layton model and the Arrhenius model are known as models for predicting changes in properties of polymer materials that deteriorate with time and temperature.

In addition, research is ongoing on models that predict mechanical properties such as tensile strength, impact strength, modulus, etc., and non-acoustic properties such as porosity, airflow resistivity, etc. of deteriorated polymer materials, but no method has been proposed to predict the acoustic performance, for example, sound absorption coefficient and sound transmission loss, of deteriorated polymer materials.

In addition, most properties of conventional models for predicting the mechanical and non-acoustic properties of deteriorated polymer materials are represented as integers, so calculations are simple and the deviation is small even when test values are directly used without additional correction, but acoustic performance is a relatively small value measured in real numbers of two decimal places or less, so calculations are cumbersome. In the case of porous polymer materials, the deviation in acoustic performance is large due to the irregular internal porous structure, which reduces the reliability of the prediction model.

### SUMMARY

The present disclosure provides a method of predicting acoustic performance of a polymer material that deteriorates over time at a certain temperature, and a program to perform the same.

Another object of the present disclosure is to provide a method of reliably predicting acoustic performance with simple calculation and low deviation by use of corrected property values in the process of predicting acoustic performance, and a program to perform the same.

The objects of the present disclosure are not limited to the foregoing. The objects of the present disclosure will be able to be clearly understood through the following description and to be realized by the means described in the claims and combinations thereof.

An aspect of the present disclosure provides a method of predicting acoustic performance of a porous polymer material, including: measuring, by a controller, initial properties of a polymer material including non-acoustic properties and mechanical properties; calculating, by the controller, properties after deterioration by inputting the initial properties into a deterioration model; and calculating, by the controller, acoustic performance after deterioration of the polymer material by inputting the properties after deterioration into an acoustic model.

In one embodiment, the polymer material may include urethane foam.

In one embodiment, the non-acoustic properties may include at least one selected from among porosity, airflow resistivity, tortuosity, viscous characteristic length, thermal characteristic length, and static thermal permeability.

In one embodiment, the mechanical properties may include at least one selected from among Young's modulus, loss factor, and Poisson ratio.

In one embodiment, the deterioration model may be application of a Layton model and an Arrhenius model in combination.

In one embodiment, the deterioration model may be used to calculate changes in the non-acoustic properties and the mechanical properties of the polymer material depending on time (t) and temperature (T).

In one embodiment, the method may further include determining constants of the deterioration model after measuring the initial properties.

As such, determining the constants may include obtaining a plurality of test data by measuring properties of the polymer material after leaving the polymer material at a predetermined temperature Tᵢ (in which i is an integer of 1 or more) for a predetermined time tⱼ (in which j is an integer of 1 or more), converting the measured properties into corrected properties using a maximum value and a minimum value among the test data, and determining constants of the deterioration model using the method of least squares based on the corrected properties.

Also, the predetermined temperature Tᵢ in determining the constants preferably includes at least three temperatures.

In one embodiment, the deterioration model may be represented by Equation 1 below.

$$P ( t , T ) = ( {P}_{M} - {P}_{m} ) \{ {α}_{0} + A exp ( - \frac{B}{T} ) log ( t ) \} + {P}_{m} \qquad [ Equation 1 ]$$

Here, P may be the properties of a polymer material, P(t,T) may be the properties after deterioration of the polymer material deteriorated at a temperature T for a time t, α₀ may be the initial corrected properties, P_{M} may be the maximum value of the properties of the polymer material measured in determining the constants, Pₘ may be the minimum value of the properties of the polymer material measured in determining the constants, A may be the Arrhenius constant calculated by determining the constants, and B may be the ratio of ideal gas constant and activation energy calculated by determining the constants.

In one embodiment, the acoustic model may include calculating acoustic performance after deterioration by applying a JCAL (Johnson-Champoux-Allard-Lafarge) or Biot-JCAL model.

In one embodiment, the acoustic model may include calculating acoustic properties after deterioration of the polymer material based on the properties after deterioration, obtaining a transfer matrix using the acoustic properties after deterioration, and calculating the acoustic performance after deterioration of the polymer material using a matrix component of the transfer matrix.

As such, calculating the acoustic properties after deterioration may include calculating equivalent acoustic characteristics based on the properties after deterioration, and calculating the acoustic properties after deterioration of the polymer material using the equivalent acoustic characteristics.

In one embodiment, the acoustic performance may include sound absorption coefficient and sound transmission loss after deterioration of the polymer material.

Another aspect of the present disclosure provides a non-transitory computer readable medium containing program instructions executed by a processor, the computer readable medium including: program instructions that measure initial properties of a polymer material comprising non-acoustic properties and mechanical properties; program instructions that calculate properties after deterioration by inputting the initial properties into a deterioration model; and program instructions that calculate acoustic performance after deterioration of the polymer material by inputting the properties after deterioration into an acoustic model.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 schematically shows obtaining corrected properties by a correction process from measured test data;

FIG. 2 shows determining the rate constant kᵢ of the Layton model by model fitting using the method of least squares based on the corrected properties;

FIGS. 3 and 4 show a program to perform a process of predicting acoustic performance of a porous polymer material according to the present disclosure;

FIG. 5 shows results of comparing non-acoustic properties predicted using the Layton model by the process of predicting acoustic performance according to the present disclosure with actual measured values;

FIG. 6 shows results of comparing non-acoustic properties predicted using the Arrhenius model by the process of predicting acoustic performance according to the present disclosure with actual measured values;

FIG. 7 is a graph showing comparison results between the sound absorption coefficient predicted by the process of predicting acoustic performance according to the present disclosure and the actual measured values; and

FIG. 8 is a set of graphs showing comparison results between the properties of the polymer material predicted according to an example using the corrected properties and a comparative example not using the corrected properties and the actual measured values.

### DETAILED DESCRIPTION

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

A method of predicting acoustic performance of a porous polymer material according to the present disclosure may include measuring initial properties of a polymer material including non-acoustic properties and mechanical properties, calculating properties after deterioration by inputting the initial properties into a deterioration model, and calculating acoustic performance after deterioration of the polymer material by inputting the properties after deterioration into an acoustic model.

Below is a detailed description of individual steps.

### Measuring Initial Properties

First, a polymer material, acoustic performance after deterioration of which is to be predicted, is selected. Here, the polymer material may include a porous polymer material, for example, polyurethane foam.

Thereafter, initial properties of the polymer material are measured. The initial properties may include non-acoustic properties and mechanical properties necessary to calculate properties and acoustic performance after deterioration using the deterioration model.

The non-acoustic properties include, for example, at least one selected from among porosity, airflow resistivity, tortuosity, viscous characteristic length, thermal characteristic length, and static thermal permeability. Also, the mechanical properties may include, for example, at least one selected from among Young's modulus, loss factor, and Poisson ratio.

Herein, definitions of individual properties included in the non-acoustic properties and mechanical properties may be understood as known in the relevant technical field, and measurement methods thereof are not particularly limited and include general measurement methods used in the relevant technical field.

### Calculating Properties after Deterioration

After measuring the initial properties of the polymer material, properties after deterioration may be calculated by inputting the initial properties into a deterioration model. Here, the deterioration model may be used to calculate the properties that change as the polymer material deteriorates by being left at any temperature (T) for any time (t), and may be application of the Layton model and the Arrhenius model in combination.

As provided herein, the calculations may be performed by a controller. For example, the calculations performed with respect to the deterioration model may be performed by one or more units or modules of the controller that constitute hardware components that form part of a controller (e.g., modules or devices of a high-level controller), or may constitute individual controllers each having a processor and memory. The controller may include one or more processors and memory.

Also, the term “properties” may be understood as non-acoustic properties or mechanical properties, unless otherwise stated.

In one embodiment, the deterioration model may be represented by Equation 1 below.

$$P ( t , T ) = ( {P}_{M} - {P}_{m} ) \{ {α}_{0} + A exp ( - \frac{B}{T} ) log ( t ) \} + {P}_{m} \qquad [ Equation 1 ]$$

Here, P may refer to the properties of the polymer material, and P(t,T) may refer to the properties after deterioration of the polymer material deteriorated by being left at a temperature T (° C.) for a time t (hour).

α₀ may refer to the initial corrected properties obtained by correcting the initial properties through determining constants to be described later.

P_{M} may refer to the maximum value of the properties of the polymer material measured in determining the constants to be described later, and Pₘ may refer to the minimum value of the properties of the polymer material measured in determining the constants to be described later.

A may refer to the Arrhenius constant calculated by determining the constants to be described later, and B may refer to the ratio of ideal gas constant and activation energy calculated by determining the constants to be described later.

In Equation 1, P_{M}, Pₘ, α₀, A, and B may be used as are until the type of polymer material is changed after being set by determining the constants to be described later. Thus, using the deterioration model according to the present disclosure, the properties after deterioration of the polymer material may be more easily predicted without additional experiments.

### Determination Constants

Meanwhile, if the constants of P_{M}, Pₘ, α₀, A, and B of Equation 1 are not determined in calculating the properties after deterioration, this step may be further performed to determine the same.

Specifically, a plurality of test data may be obtained by measuring the properties of the polymer material after leaving the polymer material at a predetermined temperature Tᵢ (in which i is an integer of 1 or more) for a predetermined time tⱼ (in which j is an integer of 1 or more).

The predetermined temperature Tᵢ may include at least three temperatures selected within the relevant temperature range in consideration of the breakdown temperature of the polymer material, acoustic performance of which is to be predicted. For example, when using urethane foam as the polymer material, the predetermined temperature Tᵢ may include at least three temperatures T₁, T₂, T₃ selected within the range of 90° C. to 170° C. Also, the predetermined time tⱼ is used to measure the properties of a polymer material that deteriorates over time at a predetermined temperature Tᵢ, and there is no limit to the number thereof, but the time interval between tⱼ and tⱼ₊₁ is preferably constant.

After obtaining the plurality of test data in this way, converting the measured properties into corrected properties may be performed using the maximum and minimum values of the properties among the test data. Converting the measured properties into corrected properties may be understood as a process for increasing the accuracy of prediction of acoustic performance by reducing the deviation of the measured properties of the porous polymer material.

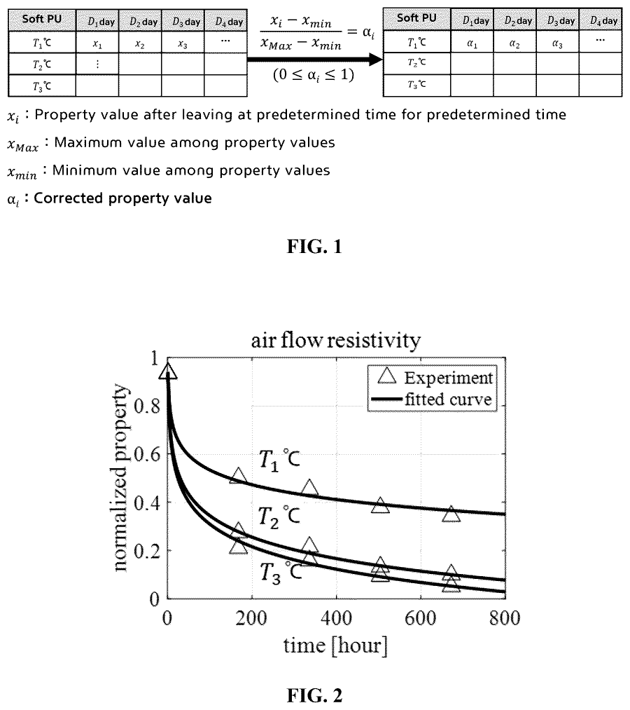

FIG. 1 schematically shows obtaining corrected properties by a correction process from the measured test data. Referring thereto, converting the measured properties into corrected properties may be represented by the following correction equation. For reference, in FIG. 1, for sake of convenience, the unit of tⱼ is set to day, not hour.

$$\frac{{P}_{i} - {P}_{m}}{{P}_{M} - {P}_{m}} = {α}_{i} \qquad [ Correction equation ]$$

Here, Pᵢ is the measured properties, P_{M} is the maximum value among the test data, Pₘ is the minimum value among the test data, and αᵢ is the corrected properties.

After converting the measured properties into corrected properties in this way, the constants of the deterioration model may be determined using the method of least squares based on the corrected properties. The method of least squares (least squares approximation) is a method of approximating the solution equation of a system, and is a method of determining a solution in which the sum of the squares of the error (SS) between the solution to be approximated and the actual solution is the minimum.

First, the rate constant k_{T}_{ᵢ}_{° C.} of the Layton model is determined using the corrected properties. More specifically, the rate constant k_{T}_{ᵢ}_{° C.} may be determined by substituting the initial properties P₀ obtained in measuring the initial properties into the above correction equation to obtain α₀, and subjecting α₀ and αᵢ to model fitting using the method of least squares based on Equation 2 below. Here, the rate constant k_{T}_{ᵢ}_{° C.} may be defined as a value when the linear fit is 0.8 or more. For reference, herein, the unit of temperature used for the rate constant is ° C., but may also be calculated in K (Kelvin) for convenience of calculation.

$${α}_{i} ( {t}_{j} , {T}_{i}^{◦} C . ) = {α}_{0} + {k}_{{T}_{i}^{◦} C .} log ( {t}_{j} ) \qquad [ Equation 2 ]$$

Here, αᵢ is the corrected properties at a predetermined temperature Tᵢ for a predetermined time tⱼ, α₀ is the initial corrected properties, and k_{T}_{ᵢ}_{° C.} is the rate constant at a predetermined temperature Tᵢ.

FIG. 2 illustrates determining the rate constant k_{T}_{ᵢ}_{° C.} of the Layton model using the corrected properties. Specifically, FIG. 2 shows the results of model fitting using the method of least squares based on Equation 2 for airflow resistivity among the properties of the polymer material.

Thereafter, the constants A and B of the Arrhenius equation are determined using the rate constant k_{T}_{ᵢ}_{° C.} calculated using the Layton model. More specifically, the Arrhenius constants A and B may be determined by model fitting using the method of least squares based on Equation 3 below using the rate constant k_{T}_{ᵢ}_{° C.}(=kᵢ(Tᵢ)) at three or more predetermined temperatures Tᵢ. Here, the Arrhenius constants A and B may be defined as values when the linear fit is 0.8 or more.

$${k}_{i} ( {T}_{i} ) = A exp ( \frac{B}{{T}_{i}} ) \qquad [ Equation 3 ]$$

Here, Tᵢ is the temperature at which kᵢ is calculated, A is the Arrhenius constant, and B is the ratio of ideal gas constant and activation energy. For the method of model fitting, reference may be made to FIG. 2 based on Equation 2.

Thereby, a corrected deterioration model as represented by Equation 1-1 below may be obtained.

$$α ( t , T ) = {α}_{0} + A exp ( - \frac{B}{T} ) log ( t ) \qquad [ Equation 1 - 1 ]$$

Equation 1-1 shows that, when a polymer material with initial corrected properties α₀ is deteriorated by being left at any temperature T for any time t, the corrected properties α may be predicted.

As such, in order to calculate the acoustic performance of the polymer material using the corrected properties α, the original property value, rather than the corrected property value, must be obtained again. Therefore, when Equation 1-1 is re-corrected according to the definition of the correction equation, Equation 1 described above may be obtained.

$$P ( t , T ) = ( {P}_{M} - {P}_{m} ) \{ {α}_{0} + A exp ( - \frac{B}{T} ) log ( t ) \} + {P}_{m} \qquad [ Equation 1 ]$$

After the constants of P_{M}, Pₘ, α₀, A, and B of Equation 1 are determined in this way, this step may be omitted.

### Calculating Acoustic Performance

After obtaining the properties after deterioration in this way, acoustic performance after deterioration of the polymer material may be calculated by inputting the properties after deterioration into an acoustic model. In one embodiment, the acoustic performance may refer to sound absorption coefficient and sound transmission loss after deterioration of the polymer material.

The acoustic model may include calculating acoustic performance after deterioration by applying the JCAL (Johnson-Champoux-Allard-Lafarge) or Biot-JCAL model. The JCAL or Biot-JCAL model may be understood as a model for calculating the acoustic performance of a porous medium using non-acoustic properties and mechanical properties.

In calculating the acoustic performance, specifically, acoustic properties after deterioration of the polymer material may be calculated based on the properties after deterioration. Calculating the acoustic properties after deterioration may include calculating equivalent acoustic characteristics based on the properties after deterioration and calculating the acoustic properties after deterioration of the polymer material using the equivalent acoustic characteristics. Here, the equivalent acoustic characteristics may include equivalent density (ρ_{eff}) and equivalent volume stiffness (K_{eff}).

After calculating the equivalent acoustic characteristics, acoustic properties after deterioration of the polymer material, such as characteristic impedance (Z_{c}) and wavenumber (k_{y}) of a sound wave penetrating the polymer material after deterioration, may be predicted using the equivalent acoustic characteristics.

A transfer matrix may be obtained using the acoustic properties after deterioration predicted thereby. The transfer matrix may be represented as a matrix below.

$$[ Transfer matrix ]$$

$$( \begin{matrix}{p}^{L} \\ {v}^{L}\end{matrix} ) = ( \begin{matrix}{T}_{11} & {T}_{12} \\ {T}_{21} & {T}_{22}\end{matrix} ) [ \begin{matrix}{p}^{R} \\ {v}^{R}\end{matrix} ]$$

Here, p^{L} and v^{L} are the incident sound pressure and incident particle velocity incident on the polymer material, respectively, and p^{R} and v^{R} are the transmitted sound pressure and transmitted particle velocity penetrating the polymer material. Also,

$${T}_{11} = cos {k}_{y} L , {T}_{12} = {jZ}_{c} sin {k}_{y} L , {T}_{21} = \frac{j sin {k}_{y} L}{{Z}_{c}}$$

and T₂₂=cosk_{y}L. Here, k_{y} is the wavenumber of a sound wave penetrating the polymer material after deterioration, and Z_{c} is the characteristic impedance of the polymer material after deterioration. L is the thickness of the polymer material.

Thereafter, the acoustic performance after deterioration of the polymer material may be calculated using the matrix component of the transfer matrix.

The acoustic performance may include sound absorption coefficient, and the sound absorption coefficient (ABS) may be calculated as follows.

$$[ Sound absorption coefficient ]$$

$$ABS = 1 - {R}^{2} , R = ( \frac{{T}_{11} - ρ c {T}_{21}}{{T}_{11} + ρ c {T}_{21}} )$$

Also, the acoustic performance may include sound transmission loss, and the sound transmission loss (STL) may be calculated as follows.

$$[ Sound transmission loss ]$$

$$STL = 10 log ( \frac{1}{τ} ) , τ = {[ \frac{2 {e}^{j {k}_{y} L}}{{T}_{11} + ( \frac{1}{ρ c} ) {T}_{12} + ( ρ c ) {T}_{21} + {T}_{22}} ]}^{2}$$

In the sound absorption coefficient and sound transmission loss, ρ is the air density and c is the speed of sound in air. Also, T₁₁, T₁₂, T₂₁, T₂₂, k_{y}, Z_{c}, and L are the same as described above.

Another aspect of the present disclosure provides a program to perform the method of predicting the acoustic performance of the polymer material described above, suitable for predicting the acoustic performance of a porous polymer material. The program may be stored in a storage medium readable by a computing device. The computing device may refer to all types of electronic devices with computing power capable of running the program for predicting acoustic performance and examples thereof may include a personal computer, smartphone, tablet, etc.

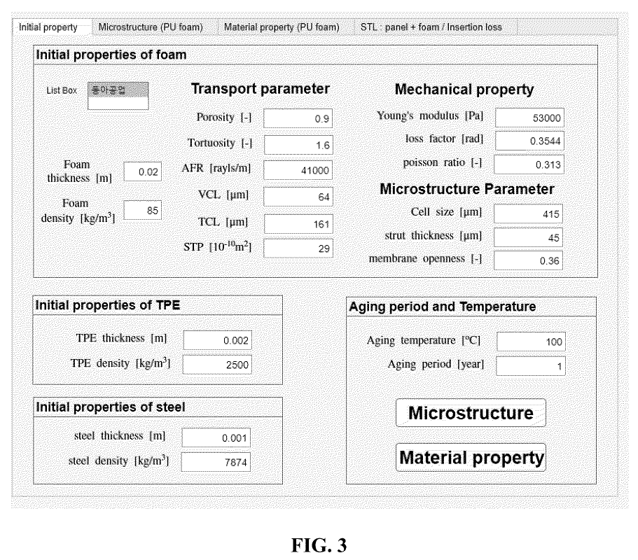

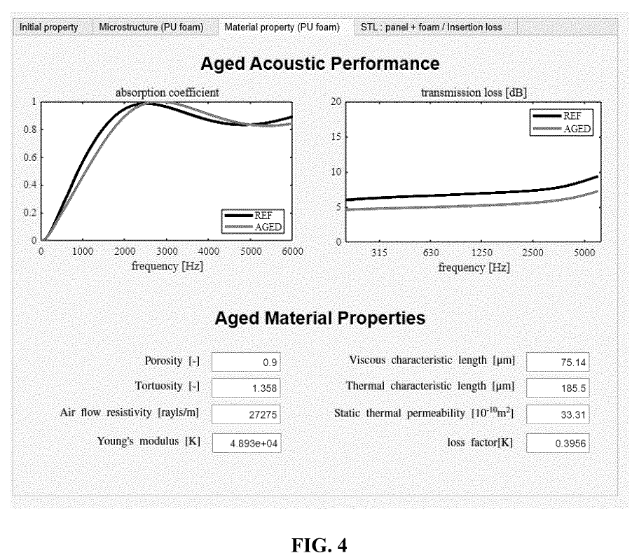

According to the program for predicting acoustic performance of the present disclosure, when inputting the initial properties of the polymer material into the program and inputting temperature and time conditions as shown in FIG. 3, the acoustic performance of the polymer material may be predicted as shown in FIG. 4.

In this way, the method of predicting the acoustic performance of the porous polymer material according to the present disclosure is capable of accurately predicting the acoustic performance of a polymer material that deteriorates with time and temperature.

In addition, unlike conventional deterioration models, the constants of the deterioration model may be determined using corrected properties and the properties after deterioration may be calculated, making it possible to more accurately predict acoustic performance after deterioration of the polymer material.

Furthermore, according to the program for predicting acoustic performance, it is possible to predict the acoustic performance of the deteriorated polymer material simply by inputting the initial properties of the material, thus predicting changes in the acoustic performance of a material used in a sound absorption and insulation part without direct long-term aging tests, thereby enabling durable design of sound absorption and insulation performance of automobiles in consideration thereof.

Moreover, when a failure criterion for a sound absorption and insulation part is defined, it is possible to calculate the lifespan of the sound absorption and insulation part under any temperature conditions by applying the same to the sound absorption and insulation deterioration model.

A better understanding of the present disclosure may be obtained through the following example and comparative example. However, these examples are not to be construed as limiting the technical spirit of the present disclosure.

### Example

Five urethane foam specimens with a thickness of 2 cm and a density of 85 kg/m³ were prepared. Thereafter, initial properties were obtained by measuring porosity, airflow resistivity, tortuosity, viscous characteristic length, thermal characteristic length, and static thermal permeability of the urethane foam specimens.

The predetermined temperatures T₁, T₂, and T₃ were set to 130° C., 140° C., and 150° C., respectively, and the predetermined times t₁, t₂, t₃, and t₄ were set to 168 hours (1 week), 336 hours (2 weeks), 504 hours (3 weeks), and 672 hours (4 weeks), respectively. The properties after deterioration of the polymer material were measured under these conditions, obtaining a plurality of test data.

The initial properties and the plurality of test data were converted into initial corrected properties and corrected properties using the correction equation. Thereafter, as in determining the constants described above, the constants of Equations 2 and 3 were determined by model fitting using the method of least squares based on Equation 2 and model fitting using the method of least squares based on Equation 3.

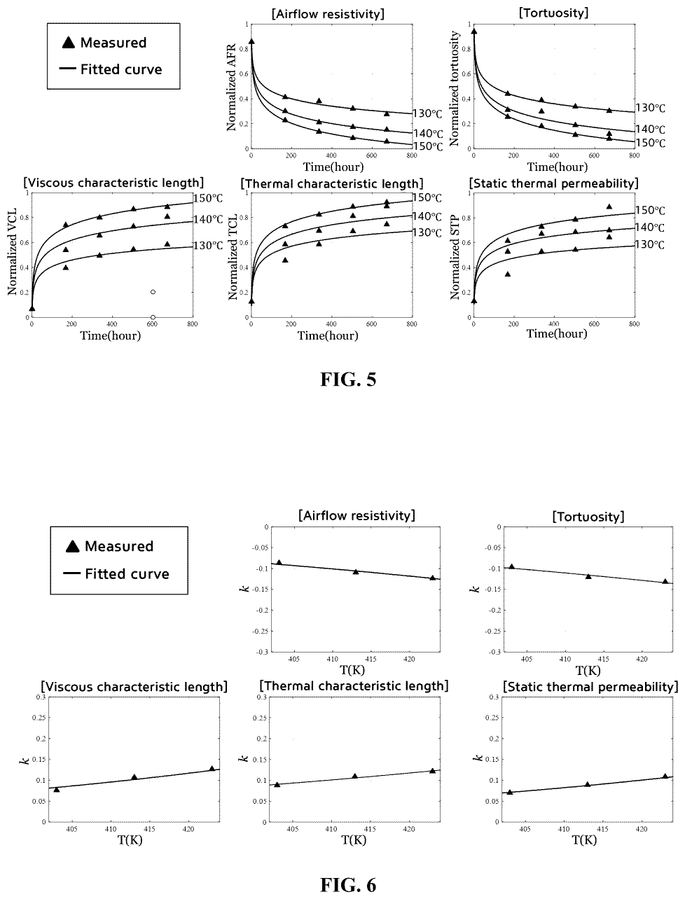

In order to confirm the accuracy of the constants determined thereby, the predicted airflow resistivity, tortuosity, viscous characteristic length, thermal characteristic length, and static thermal permeability of the specimens based on Equations 2 and 3 and the actual measured properties of the specimens were compared, and the results thereof are shown in FIGS. 5 and 6. Here, the porosity of the specimens was maintained at about 0.9 before and after deterioration, confirming that the porosity was not a property with high variability due to deterioration.

As a result of using a known method for measuring accuracy of the regression analysis model based on the results of FIGS. 5 and 6, the coefficient of determination for the five specimens was calculated to be 0.8 or more. In general, when the coefficient of determination is 0.7 or more, the model and actual measurement results may be judged to be valid.

Thereafter, the determined constants were substituted into Equation 1 or Equation 1-1, completing each equation.

The initial properties were input into Equation 1 in which the constants were determined, calculating properties after deterioration. Based thereon, acoustic properties after deterioration of the polymer material were calculated, and then a transfer matrix was obtained using the acoustic properties. Using the matrix component of the transfer matrix, the sound absorption coefficient after deterioration of the polymer material was calculated.

### Comparative Example

The constants of Equation 1 were determined in the same manner as in Example, with the exception that converting the initial properties and the plurality of test data into initial corrected properties and corrected properties using the correction equation was not performed. The sound absorption coefficient was calculated.

### Test Example 1

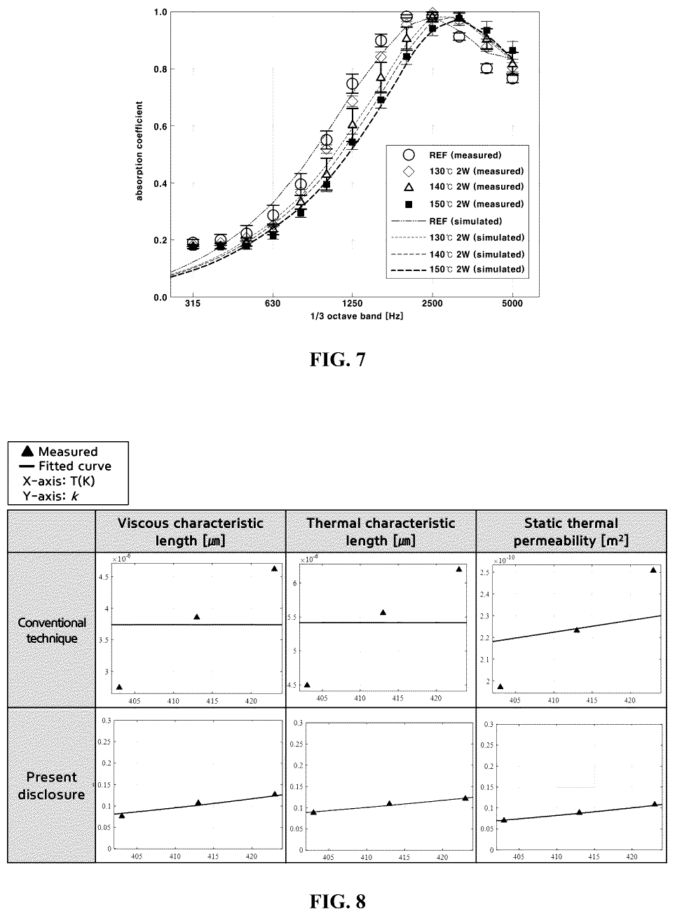

The initial sound absorption coefficient of the prepared polymer material was measured, and the polymer material was left at 130°° C., 140°° C., and 150° C. for two weeks, after which the sound absorption coefficient thereof was measured. The results thereof are shown in FIG. 7. Also, the sound absorption coefficient was calculated under the same conditions using the method of predicting acoustic performance according to Example, and the results thereof are shown in FIG. 7.

Referring to FIG. 7, it can be seen that prediction curves similar to the actual sound absorption coefficient were obtained for the five specimens.

### Test Example 2

Viscous characteristic length, thermal characteristic length, and static thermal permeability of the polymer material predicted using the method of predicting acoustic performance according to Example, and viscous characteristic length, thermal characteristic length, and static thermal permeability of the polymer material predicted using the method of predicting acoustic performance according to Comparative Example are shown in FIG. 8.

According to FIG. 8, it can be seen that the fit with the actual measured values was improved in Example using the corrected properties compared to Comparative Example not using the corrected properties.

As is apparent from the above description, a method of predicting acoustic performance of a porous polymer material according to the present disclosure is capable of accurately predicting acoustic performance of a polymer material that deteriorates with time and temperature.

In addition, unlike conventional deterioration models, the constants of a deterioration model are determined using corrected properties and the properties after deterioration are calculated, making it possible to more accurately predict acoustic performance after deterioration of the polymer material.

The effects of the present disclosure are not limited to the foregoing. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A method of predicting acoustic performance of a porous polymer material, the method comprising:
measuring, by a controller, initial properties of a polymer material comprising non-acoustic properties and mechanical properties;
calculating, by the controller, properties after deterioration by inputting the initial properties into a deterioration model; and
calculating, by the controller, acoustic performance after deterioration of the polymer material by inputting the properties after deterioration into an acoustic model.

2. The method of claim 1, wherein the polymer material comprises urethane foam.

3. The method of claim 1, wherein the non-acoustic properties comprise at least one of porosity, airflow resistivity, tortuosity, viscous characteristic length, thermal characteristic length, or static thermal permeability.

4. The method of claim 1, wherein the mechanical properties comprise at least one of Young's modulus, loss factor, or Poisson ratio.

5. The method of claim 1, wherein the deterioration model incorporates a Layton model and an Arrhenius model in combination.

6. The method of claim 1, wherein the deterioration model is used to calculate changes in the non-acoustic properties and the mechanical properties of the polymer material depending on time (t) and temperature (T).

7. The method of claim 1, further comprising determining constants of the deterioration model after measuring the initial properties.

8. The method of claim 7, wherein determining the constants comprises:
obtaining a plurality of test data by measuring properties of the polymer material after leaving the polymer material at a predetermined temperature Tᵢ (in which i is an integer of 1 or more) for a predetermined time tⱼ (in which j is an integer of 1 or more);
converting the measured properties into corrected properties using a maximum value and a minimum value of the properties among the test data; and
determining constants of the deterioration model using a method of least squares based on the corrected properties.

9. The method of claim 8, wherein the predetermined temperature Tᵢ in determining the constants comprises at least three temperatures.

10. The method of claim 1, wherein the deterioration model is represented by Equation 1 below:
$$P ( t , T ) = ( {P}_{M} - {P}_{m} ) \{ {α}_{0} + A exp ( - \frac{B}{T} ) log ( t ) \} + {P}_{m} \qquad [ Equation 1 ]$$
(in which P is properties of a polymer material; P(t,T) is properties after deterioration of the polymer material deteriorated at a temperature T for a time t; α₀ is initial corrected properties; P_{M} is a maximum value of the properties of the polymer material measured in determining constants; Pₘ is a minimum value of the properties of the polymer material measured in determining the constants; A is an Arrhenius constant calculated by determining the constants; and B is a ratio of an ideal gas constant and activation energy calculated by determining the constants).

11. The method of claim 1, wherein the acoustic model comprises calculating acoustic performance after deterioration by applying a JCAL (Johnson-Champoux-Allard-Lafarge) or Biot-JCAL model.

12. The method of claim 1, wherein the acoustic model comprises:
calculating acoustic properties after deterioration of the polymer material based on the properties after deterioration;
obtaining a transfer matrix using the acoustic properties after deterioration; and
calculating the acoustic performance after deterioration of the polymer material using a matrix component of the transfer matrix.

13. The method of claim 12, wherein calculating the acoustic properties after deterioration comprises:
calculating equivalent acoustic characteristics based on the properties after deterioration, and
calculating the acoustic properties after deterioration of the polymer material using the equivalent acoustic characteristics.

14. The method of claim 1, wherein the acoustic performance comprises sound absorption coefficient and sound transmission loss after deterioration of the polymer material.

15. A non-transitory computer readable medium containing program instructions executed by a processor, the computer readable medium comprising:
program instructions that measure initial properties of a polymer material comprising non-acoustic properties and mechanical properties;
program instructions that calculate properties after deterioration by inputting the initial properties into a deterioration model; and
program instructions that calculate acoustic performance after deterioration of the polymer material by inputting the properties after deterioration into an acoustic model.

16. The non-transitory computer readable medium of claim 15, wherein the program instructions that calculate acoustic performance comprise predicting acoustic performance of the polymer material.

17. The non-transitory computer readable medium of claim 15, wherein the polymer material comprises urethane foam.

18. The non-transitory computer readable medium of claim 15, wherein the non-acoustic properties comprise at least one of porosity, airflow resistivity, tortuosity, viscous characteristic length, thermal characteristic length, or static thermal permeability.

19. The non-transitory computer readable medium of claim 15, wherein the mechanical properties comprise at least one of Young's modulus, loss factor, or Poisson ratio.

20. The non-transitory computer readable medium of claim 15, wherein the deterioration model incorporates a Layton model and an Arrhenius model in combination.
